(19) United States
(12) Patent Application Publication
(10) Pub. No.: US 2024/0314578 A1
(43) Pub. Date: Sep. 19, 2024

(54) CELL EDGE PREDICTOR FOR OPTIMIZED ROAMING

(71) Applicant: Cisco Technology, Inc., San Jose, CA (US)

(72) Inventors: Jerome Henry, Pittsboro, NC (US); Federico Lovison, Fontanelle (IT); Robert E. Barton, Richmond (CA); Sukrit Dasgupta, Boxborough, MA (US)

(73) Assignee: Cisco Technology, Inc., San Jose, CA (US)

(21) Appl. No.: 18/603,956

(22) Filed: Mar. 13, 2024

Related U.S. Application Data
(60) Provisional application No. 63/489,908, filed on Mar. 13, 2023.

(51) Int. Cl. H04W 16/18; H04W 48/16

(52) U.S. Cl. CPC H04W 16/18; H04W 48/16

(57) ABSTRACT

Cell edge prediction for optimized roaming may be provided. Cell edge prediction can include predicting cell edges for a plurality of APs including a connected AP and one or more additional APs. A cell edge prediction can be for a client connected to the connected AP. The cell edge prediction may comprise an indication of one or more candidate APs for the client to roam to of the one or more additional APs and an estimated time the client will reach the cell edge of the connected AP. After generating the cell edge prediction, the cell edge prediction can be transmitted to the client.

### RELATED APPLICATION

Under provisions of 35 U.S.C. § 119(e), Applicant claims benefit of U.S. Provisional Application No. 63/489,908, filed Mar. 13, 2023, which is incorporated herein by reference.

### TECHNICAL FIELD

The present disclosure relates generally to cell edge prediction for optimized roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment;

FIG. 2 is a block diagram of an example Access Point (AP) configuration;

FIG. 3 is a block diagram of a building with APs deployed;

FIG. 4 is a flow chart of a method for cell edge prediction; and

FIG. 5 is a block diagram of a computing device.

### DETAILED DESCRIPTION

### Overview

Cell edge prediction for optimized roaming may be provided. Cell edge prediction can include predicting cell edges for a plurality of APs including a connected AP and one or more additional APs. A cell edge prediction can be for a client connected to the connected AP. The cell edge prediction may comprise an indication of one or more candidate APs for the client to roam to of the one or more additional APs and an estimated time the client will reach the cell edge of the connected AP. After generating the cell edge prediction, the cell edge prediction can be transmitted to the client.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming operations may occur when a client, such as a Station (STA), determines to roam to a new AP. The client may roam to a new AP when moving out of range of the currently connected to AP by scanning for available APs to roam to and selecting one of the available APs. However, the client's AP scanning and selection process may be time consuming, for example when there are many candidate APs to scan and choose from, and lead to connection interruptions.

For typical roaming operations, a client may utilize a Received Signal Strength Indicator (RSSI) threshold to determine when to roam to a new AP. For example, the client may use a RSSI threshold of −70 decibel-milliwatts (dBm) to determine that the client is near or at the edge of the cell of the currently connected AP. Clients may also use a combination of RSSI thresholds and failure events to determine whether the client is near or at the edge of the cell. An example evaluation of failure events may include determining whether more than a threshold number of unsuccessful transmissions has occurred at a specific Modulation and Coding Scheme (MCS) (e.g., a Minstrel backup MCS).

Roaming may be a key field for optimization or improvement using machine learning techniques. The development of the Institute of Electrical and Electronics Engineers (IEEE) 802.11bn standard (Wi-Fi 8), the successor to the IEEE 802.11be standard (i.e., Wi-Fi 7), has included the consideration of implementing machine learning techniques to optimize IEEE 802.11 cell operations. For example, one of the envisioned implementations includes performance prediction by the AP, other network infrastructure (e.g., the network controller), and/or by the client. The device that performs the performance prediction may share information associated with the conclusions derived from these predictions (e.g., the AP sharing information with the client, the client sharing information with the AP).

Optimizing or otherwise improving roaming may be necessary as networks experience an increase of roaming clients because the client Quality of Service (QOS) can be impacted due to the time a client takes to determine which AP to roam to. To optimize or otherwise improve roaming, systems, methods, and the like are described herein to identify when a client is near or at the edge of a cell and is about to lose operational efficiency in its exchanges with the currently connected to AP (e.g., outside of the connected to AP range and/or another AP can provide an improved connection). Once the AP identifies that the client is near or at an edge, the AP may provide an edge of the cell indication to the client indicating the prediction. The client may use the edge of cell indication to determine to roam to a new AP without potential interruptions in service that can arise when a client attempts to roam without the edge of cell indication.

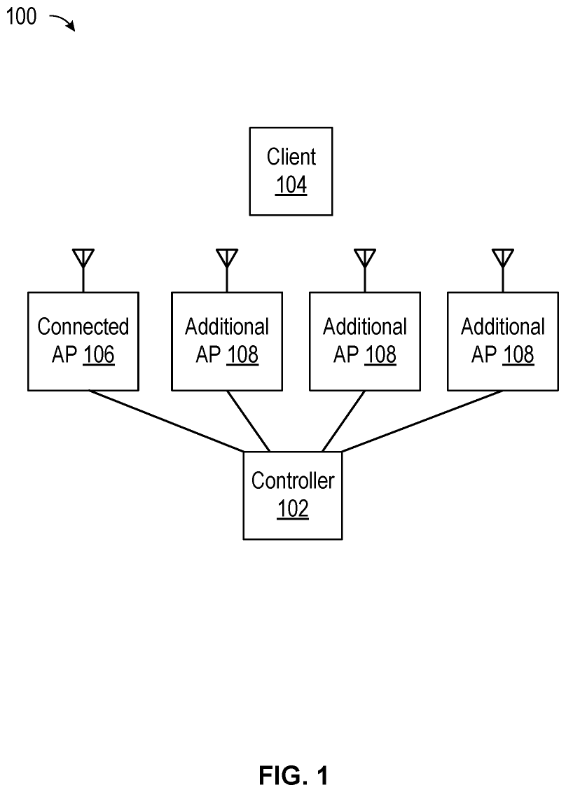

FIG. 1 is a block diagram of an operating environment 100. The operating environment 100 may include a controller 102, a client 104, a connected AP 106 (i.e., the AP client 104 is connected to or otherwise communicating with), and three additional APs 108. The controller 102 may be any network controller (e.g., a Wireless Local Area Network (WLAN) controller) and may manage the connected AP 106 and the additional APs 108 to allow wireless devices such as the client 104 to connect to the network. In some examples, the connected AP 106 and the additional APs 108 may connect directly to the network or connect through a gateway device not shown. In some embodiments, the operations of the controller 102 described herein may be performed by one or more of the connected AP 106, the additional APs 108 and/or another device, and vice versa. The connected AP 106 and the additional APs 108 have a wired connection to the controller 102 in this example but may wirelessly connect to the controller 102 in other examples. The operating environment 100 is an example configuration and there may be a different number of controllers 102, clients 104, additional APs 108, and/or other devices in further examples.

The controller 102 and/or the connected AP 106 may perform a cell edge prediction to increase the speed the client 104 can perform roaming compared to when the client 104 performs roaming without assistance. The controller 102 and/or the connected AP 106 may consider two scenarios when performing cell edge prediction. In a given cell, the controller 102 and/or the connected AP 106 may define a cell edge as (i) the position beyond which the ability of the client 104 to exchange data with the network through the connected AP 106 or additional APs 108 associated with the cell edge becomes marginal (i.e., at the edge of acceptable performance), or (ii) the position beyond which one or more of the connected AP 106 and the additional APs 108 can provide a better connection or otherwise better performance for the client 104 than the connected AP 106 or additional AP 108 associated with the cell edge. The position of the cell edge in the first scenario where the controller 102 and/or the connected AP 106 consider a cell edge to be the position beyond which the ability of the client 104 to exchange data with the network through the connected AP 106 becomes marginal may be determined based on the RSSI values (e.g., −70 dBm), the traffic type the client 104 intends to transmit and/or receive (e.g., the sensitivity to delay, jitter, retries, and the like of the traffic type), and/or the like. The position of the cell edge for the second scenario where the controller 102 and/or the connected AP 106 consider a cell edge to be the point at which one of the additional APs 108 can provide better performance may be determined based on an additional AP 108 having a lower client load for sensitive traffic, better associated RSSI values, latency, delay, and/or the like compared to the connected AP 106.

To enable the cell edge prediction, the controller 102, the connected AP 106, the additional APs 108, and/or other network devices that may perform the cell edge prediction may undergo training based on roaming training parameters including previous roaming data, network data, client data, and/or the like. For example, the training may be a regression training based on roaming training parameters. The roaming training parameters can the previous AP of the client 104 and/or other clients connected to the connected AP 106 (i.e., the identity of the AP(s) the client 104, previous clients, and/or other current clients that the client 104 are initially connected to before roaming to or otherwise connecting to the connected AP 106), the RSSI of the client 104 and/or other clients at Basic Service Set (BSS) entry, the traffic mix profiles of the client 104 and/or other clients, the MCS slope, the RSSI of the client 104 and/or other clients at the roaming time, the next AP previous clients roamed to when disconnecting from the connected AP 106, and/or the like. Thus, the controller 102, the connected AP 106, the additional APs 108, and/or other network devices may determine the cell edge prediction based on historical roaming paths of other clients. The traffic mix profiles may indicate the type of traffic exchanged with the client 104 and/or other clients. In some embodiments, the training parameters may include Key Performance Indicators (KPIs) for sensitive traffic, such as traffic in the highest User Priority (UP), including, KPIs for the max Access Category (AC) (e.g., AC Video (AC_VI)), retry count over the pre-roaming interval, Buffer Status Report (BSR) values, packet size and interval for Uplink (UL) and Downlink (DL), whether a Differentiated Services Code Point (DSCP) flag is present, and/or the like.

During the training phase and before the cell edge prediction is enabled, clients may roam based on the RSSI thresholds and/or failure events. The controller 102, the connected AP 106, the additional APs 108, and/or other network devices may generate a roaming area defined by a cell edge for each AP (e.g., the connected AP 106 and the additional APs 108) based on the training. The roaming areas may be defined by cell edges including a line, such as the edge of a circle or surface of a sphere, or by an area, such as a donut or hollow sphere. Thus, the roaming area may be built based on the RSSI thresholds, failure events, and historical data associated with client roaming.

In some embodiments, the controller 102, the connected AP 106, the additional APs 108, and/or other network devices may collect the queue depth of the APs and fill-empty-rate during training. The controller 102, the connected AP 106, the additional APs 108, and/or other network devices may evaluate the queue depth and fill-empty-rate when clients roam to determine the ability of APs to accommodate additional clients and identify why clients choose to roam to the next APs. Additionally, the cell edge prediction may be based on the trajectory of the client 104. The trajectory of the client 104 is not always known by the controller 102 and/or the connected AP 106. So, the controller 102 and/or the connected AP 106 may estimate the trajectory based on previous client trajectories and use the estimated trajectory in the cell edge prediction, for example to recommend one or more of the additional APs 108 for the client 104 to roam to.

After the training phase, the controller 102, the connected AP 106, and/or other network devices may be able to generate the cell edge prediction for the client 104. The cell edge prediction can include the likelihood that the client 104 will reach the edge of the cell within a period and which of the additional APs 108 has the highest likelihood of providing better service than the connected AP 106. The estimation of the period may be an estimated time the client 104 will reach the edge of the cell, such as a prediction that the client 104 will reach the edge of the cell in five seconds.

As described above the cell edge prediction may be based on historical roaming data, previous roaming actions by clients. For example, the controller 102 may estimate the time and which additional AP 108 to roam to based on the statistics of previous clients roaming at that time to a new AP, so the controller 102 predicts that the client 104 should roam to a determined AP at a determined time because the historical data indicates that roaming to the determined AP at that time has been historically successful. For example, clients may typically move in different patterns throughout the day and week (e.g., entering a building in the morning and exiting the building in the evening). The cell edge prediction may additionally be based on the Service Set Identifier (SSID) of the client 104 and/or other clients because clients on different SSIDs may follow different roaming paths (e.g., clients that are guests may only have access to certain parts of a building, clients that are employees can enter office area, etc.). Additionally or alternatively, the cell edge prediction may be service based, and the controller 102 may determine the cell edge prediction (e.g., candidate AP recommendation and time to roam) based on whether the client 104 will maintain the traffic it is transmitting and/or receiving if the client 104 will roam within the estimated period to a recommended AP.

The cell edge prediction may include a list of candidate APs (e.g., one or more of the additional APs 108) with probabilities of roaming to the candidate APs. For example, a first candidate AP may have a probability of sixty percent, a second candidate AP may have a probability of thirty percent, and a third candidate AP may have a probability of ten percent. The probabilities can be provided to the client 104 to inform the client 104 that the cell edge prediction indicates that the first candidate AP has the highest likelihood of being connected to, followed by the second and third candidate APs.

Once the controller 102 and/or the connected AP 106 determine the cell edge prediction, the connected AP 106 can then share the cell edge prediction with the client 104. In some examples, the connected AP 106 may share the cell edge prediction when the likelihood of the client 104 roaming, either out of necessity or to experience a better connection, is above a configurable roaming threshold. The connected AP 106 may transmit a modified IEEE 802.11v unsolicited action frame including the cell edge prediction to transmit the prediction to the client 104. The action fame may leverage the BSS Transition Management (BTM) frame structure, and augment the BTM frame to convey the information associated with the cell edge prediction. In another embodiment, the action frame may comprise an 802.11k neighbor report that may include a subset of candidate APs and transition parameters (e.g., the most likely AP the client 104 should roam to). The frame may include the probabilities of roaming to each candidate AP, the optimal time to perform the roaming, and additional information such as when there is a specific traffic type (e.g., video). When the client 104 is exchanging traffic associated with video, the additional information may include the estimated throughput available (e.g., X Megabits per second), estimated delay (e.g., less than 30 milliseconds), the latency, and/or the like when roaming to each candidate AP.

The client 104 can use the cell edge prediction to perform zero scan roaming because the controller 102 and/or the connected AP 106 has performed the scan of the candidate APs while generating the cell edge prediction. Additionally, the client 104 can request the cell edge predictions, such as when the client 104 detects that it should roam, or the connected AP 106 can transmit the cell edge prediction directly without a request. For example, the connected AP 106 can transmit the cell edge prediction to the client 104 based on the connected AP 106 determining the RSSI of the client 104 is at a threshold. Alternatively, the connected AP 106 can instruct the client 104 to request a cell edge prediction at a RSSI threshold. For example, when the RSSI is −60 dBm, the client 104 should consider roaming to a new AP and request the cell edge prediction.

Information about how the cell edge prediction was made may also be provided to the client 104. For example, the communication (e.g., the action frames described above) may indicate the algorithms and historical data used to recommend candidate APs to the client 104 for the client 104 to determine how much weight to give to the recommendations, for example in addition to the roaming algorithm of the client 104. For example, the information may include how the recommendation was come up with, such as available information (e.g., only been predicting for five minutes based on twenty-five roams, been predicting for six months based on five million roams), how accurate the controller 102 believes the prediction is, and/or the like. Thus, the client 104 may determine to trust the recommendation based on the believed accuracy, when the available information is sufficient (e.g., the five million roaming history case), etc. and determine to perform backup checks if the recommendation is considered poor based on the believed accuracy, when the available information may not be sufficient (e.g., the twenty-five roaming history case), etc.

The controller 102 and/or the connected AP 106 may also request feedback from the client 104 to determine if the cell edge prediction was accurate. For example, the controller 102 and/or the connected AP may request to verify the position of the cell edge, verify that the estimated time reaching the cell edge was accurate, the identity of the additional AP 108 the client 104 determined to roam to so the controller 102 can compare the recommended AP to the actual AP the client 104 roamed to, and/or the like. The client 104 can respond to the request with the requested information. For example, the client 104 can provide reason codes that indicate the requested information, such as whether a candidate AP had too low of a signal, a candidate AP had too high of a load, and/or the like, so the client 104 connected to a different candidate AP than the one suggested, the position of the cell edge, the time the client 104 reached the cell edge, etc.

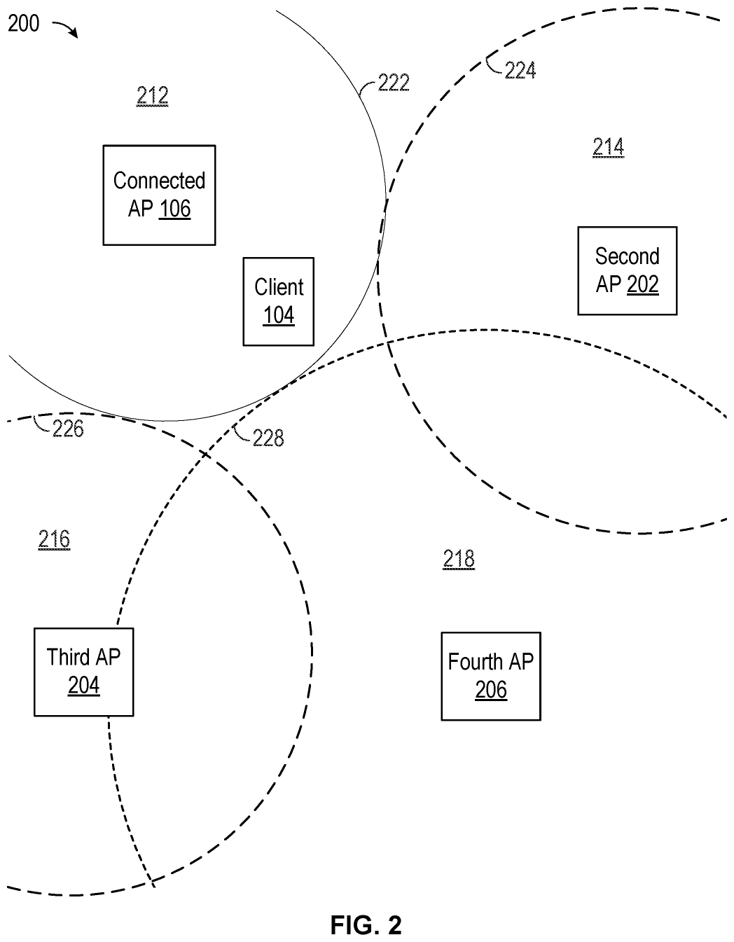

FIG. 2 is a block diagram of an example AP configuration 200. The AP configuration 200 may include the connected AP 106, a second AP 202, a third AP 204, a fourth AP 206, and the client 104. The second AP 202, the third AP 204, the fourth AP 206 may be the additional APs 108 shown in FIG. 1 with identifying labels for the convenience and clarity of the following description.

The AP configuration 200 may also include the connected AP range 212 with limits indicated by the connected AP cell edge 222, the second AP range 214 with limits indicated by the second AP cell edge 224, the third AP range 216 with limits indicated by the third AP cell edge 226, and the fourth AP range 218 with limits indicated by the fourth AP cell edge 228. The connected AP range 212, the second AP range 214, the third AP range 216, and the fourth AP range 218 are shown for example purposes only, and the AP ranges may be different in other examples. For example, the client 104 may be in the range of the connected AP 106, the second AP 202, the third AP 204, and the fourth AP 206 at its shown position, with a high enough RSSI associated with the second AP 202, the third AP 204, and the fourth AP 206, to consider roaming to one of the second AP 202, the third AP 204, or the fourth AP 206.

The controller 102, the connected AP 106, the second AP 202, the third AP 204, the fourth AP 206, and/or other network devices may determine the connected AP range 212 with limits indicated by the connected AP cell edge 222, the second AP range 214 with limits indicated by the second AP cell edge 224, the third AP range 216 with limits indicated by the third AP cell edge 226, and the fourth AP range 218 with limits indicated by the fourth AP cell edge 228 according to methods described above. For example, the AP configuration 200 may be the described first scenario, and the controller 102 and/or other devices consider a cell edge to be the position beyond which the ability of the client 104 to exchange data with the network through the respective AP becomes marginal. Thus, the connected AP cell edge 222, second AP cell edge 224, the third AP cell edge 226, and the fourth AP cell edge 228 may be the positions beyond which the ability of the client 104 to exchange data with the network through the respective AP becomes marginal.

The controller 102 may determine a cell edge prediction for the client 104, including the likelihood that the client 104 will reach the connected AP cell edge 222 within a period and which of the second AP 202, the third AP 204, and the fourth AP 206 has the highest likelihood of providing better service than the connected AP 106. The determination of the which of the second AP 202, the third AP 204, and the fourth AP 206 has the highest likelihood of providing better service than the connected AP 106 may be based on the type of traffic the client 104 wants to transmit and/or receive and/or other factors described above. If the controller 102 determines the client 104 will reach the connected AP cell edge 222 within a configurable time frame, the controller 102 may cause the connected AP 106 to transmit the cell edge prediction to the client 104. The client 104 may then use the cell edge prediction to determine when to roam and determine to roam to the second AP 202, the third AP 204, or the fourth AP 206.

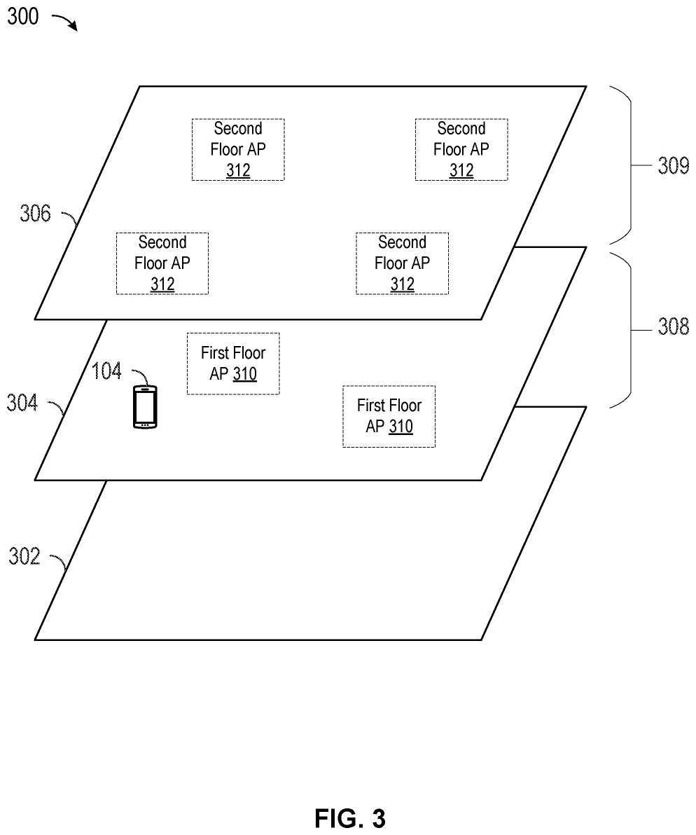

FIG. 3 is a block diagram of a building 300 with APs deployed. The building 300 may include a floor 302, a floor-ceiling assembly 304, and a roof 306. The building 300 therefore includes a first floor 308 defined by the floor 302 and the floor-ceiling assembly 304 and a second floor 309 defined by the floor-ceiling assembly 304 and the roof 306. The building 300 may also include first floor APs 310 attached to the ceiling portion of the floor-ceiling assembly and therefore be located on the first floor 308. Similarly, the building 300 may also include second floor APs 312 attached to the roof 306 and located on the second floor 309. The client 104 may be located on the second floor 309 in this example.

The first floor APs 310 and the second floor APs 312 may be positioned close enough to have overlapping ranges, so the client 104 may never reach a position in the building 300 where the client is out of the range of the AP the client initially connects to. While the client 104 may remain within the range of the AP it is connected to while moving through the building, one or more of the first floor APs 310 and/or the second floor APs may provide improved coverage if the client 104 roams to one of them. Therefore, the cell edges of the first floor APs 310 and the second floor APs 312 may be determined according to the second scenario described above. The controller 102 may thus consider the cell edges of the first floor APs 310 and the second floor APs 312 to be the point at which one of the additional APs 108 can provide better performance. The controller 102 may identify the cell edges of first floor APs 310 and the second floor APs 312 based on the RSSIs associated with the first floor APs 310 and the second floor APs 312 and the activity of clients on the first floor APs 310 and the second floor APs 312, such the number of clients connected to each AP, the actions of the clients, how much airtime, bandwidth, etc. the clients are using, and/or the like.

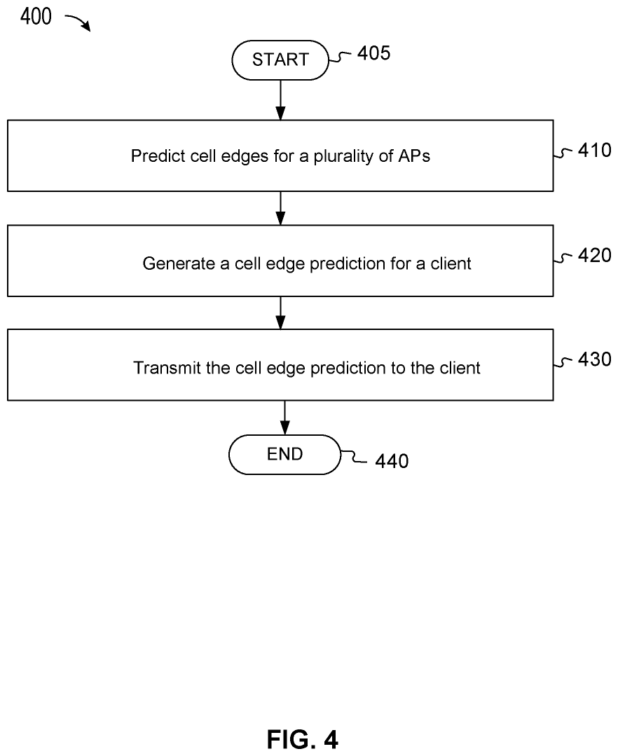

FIG. 4 is a flow chart of a method 400 for cell edge prediction. The method 400 may begin at starting block 405 and proceed to operation 410. In operation 410, cell edges are predicted for a plurality of APs. For example, the controller 102, the connected AP 106, and/or the additional APs 108 predict cell edges for the connected AP 106 and the additional APs 108.

As described above, the cell edges may be any one of: (i) positions beyond which an ability of the client 104 to exchange data with a network through the connected AP 106 or additional AP 108 associated with the cell edge becomes marginal or (ii) positions beyond which one or more of the connected AP 106 and the additional APs 108 can provide a better connection for the client than the connected AP 106 or additional AP 108 associated with the cell edge. The positions of the cell edges may be based on any of the data described above, including the traffic type of the client 104, one or more RSSIs of the client 104, latency, delay, and/or the like.

Predicting the cell edges can include performing regression training based on one or more roaming training parameters as described above. For example, the roaming training parameters can include one or more previous APs (i.e., the AP clients were connected to before connecting to the connected AP 106), RSSI values at BSS entry, traffic mix profiles, MCS slopes, RSSI values when roaming, next APs (i.e., the APs clients roamed to after connecting to the connected AP 106, KPIs for sensitive traffic, and/or the like for the client 104 and other clients.

In operation 420, a cell edge prediction is generated for a client. For example, the controller 102 and/or the connected AP 106 generates the cell edge prediction for the client 104. The cell edge prediction can include an indication of one or more candidate APs for the client to roam to of the additional APs 108 and an estimated time the client 104 will reach the cell edge of the connected AP 106. As described above, generating the cell edge prediction can be based on historical roaming data, SSIDs, trajectory of the client 104, an estimation of whether the client 104 can maintain its traffic, a time of day, and/or the like. In some examples, the cell edge prediction can include probabilities of roaming to the one or more candidate APs, information associated with how the cell edge prediction is determined, and/or the like.

In operation 430, the cell edge prediction is transmitted to the client. For example, the connected AP 106 transmits the cell edge prediction to the client 104. The client 104 can select which AP to roam to based on the cell edge prediction, evaluate the accuracy of the cell edge prediction, and/or the like. In some examples, the connected AP 106 can request feedback on the cell edge prediction from the client 104. The feedback can be included in the cell edge prediction transmission or another transmission. The client 104 can provide feedback to the connected AP 106 as described above. The method 400 may conclude at ending block 440.

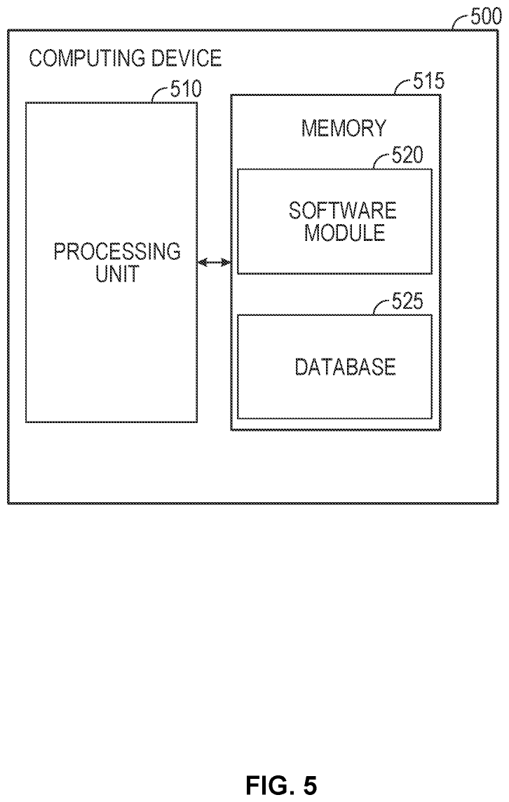

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for cell edge prediction for optimized roaming with respect to FIG. 1, FIG. 2, FIG. 3, and FIG. 4. Computing device 500, for example, may provide an operating environment for the controller 102, the client 104, the connected AP 106, the additional APs 108, the second AP 202, the third AP 204, the fourth AP 208, and the like. The controller 102, the client 104, the connected AP 106, the additional APs 108, the second AP 202, the third AP 204, the fourth AP 208, and the like may operate in other environments and are not limited to computing device 500.

Computing device 500 may be implemented using a Wi-Fi AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
predicting cell edges for a plurality of Access Points (APs) including a connected AP and one or more additional APs;
generating a cell edge prediction for a client connected to the connected AP, the cell edge prediction comprising:
an indication of one or more candidate APs for the client to roam to of the one or more additional APs, and
an estimated time the client will reach the cell edge of the connected AP; and
transmitting the cell edge prediction to the client.

2. The method of claim 1, wherein the cell edges are any one of: (i) positions beyond which an ability of the client to exchange data with a network through the connected AP or additional AP associated with the cell edge becomes marginal or (ii) positions beyond which one or more of the connected AP and the one or more additional APs can provide a better connection for the client than the connected AP or additional AP associated with the cell edge.

3. The method of claim 2, where the positions of the cell edges are based on any one of: (i) a traffic type of the client, (ii) one or more Received Signal Strength Indicators (RSSIs) of the client, (iii) latency, (iv) delay, or (v) any combination of (i)-(v).

4. The method of claim 1, wherein predicting the cell edges comprises:
performing regression training based on one or more roaming training parameters.

5. The method of claim 4, wherein the one or more roaming training parameters comprise any one of: (i) one or more previous APs, (ii) one or more RSSI values at Basic Service Set entry, (iii) one or more traffic mix profiles, (iv) one or more Modulation and Coding Scheme slopes, (v) one or more RSSI values when roaming, (vi) one or more next APs, (vii) Key Performance Indicators for sensitive traffic, or (viii) any combination of (i)-(vii), for one or more of the client and one or more other clients.

6. The method of claim 1, wherein generating the cell edge prediction is based at least in part on any one of: (i) historical roaming data, (ii) a Service Set Identifier of the client, (iii) a trajectory of the client, (iv) an estimation of whether the client can maintain its traffic, (v) a time of day, or (vi) any combination of (i)-(v).

7. The method of claim 1, wherein the cell edge prediction further comprises any one of: (i) probabilities of roaming to the one or more candidate APs, (ii) information associated with how the cell edge prediction is determined, or (iii) a combination of (i) and (ii).

8. The method of claim 1, further comprising:
requesting feedback of the cell edge prediction from the client; and
receiving the feedback from the client.

9. A system comprising:
a memory storage; and
a processing unit coupled to the memory storage, wherein the processing unit is operative to:
predict cell edges for a plurality of Access Points (APs) including a connected AP and one or more additional APs;
generate a cell edge prediction for a client connected to the connected AP, the cell edge prediction comprising:
an indication of one or more candidate APs for the client to roam to of the one or more additional APs, and
an estimated time the client will reach the cell edge of the connected AP; and
transmit the cell edge prediction to the client.

10. The system of claim 9, wherein the cell edges are any one of: (i) positions beyond which an ability of the client to exchange data with a network through the connected AP or additional AP associated with the cell edge becomes marginal or (ii) positions beyond which one or more of the connected AP and the one or more additional APs can provide a better connection for the client than the connected AP or additional AP associated with the cell edge.

11. The system of claim 10, where the positions of the cell edges are based on any one of: (i) a traffic type of the client, (ii) one or more Received Signal Strength Indicators (RSSIs) of the client, (iii) latency, (iv) delay, or (v) any combination of (i)-(v).

12. The system of claim 9, wherein predicting the cell edges comprises:
performing regression training based on one or more roaming training parameters.

13. The system of claim 12, wherein the one or more roaming training parameters comprise any one of: (i) one or more previous APs, (ii) one or more RSSI values at Basic Service Set entry, (iii) one or more traffic mix profiles, (iv) one or more Modulation and Coding Scheme slopes, (v) one or more RSSI values when roaming, (vi) one or more next APs, (vii) Key Performance Indicators for sensitive traffic, or (viii) any combination of (i)-(vii), for one or more of the client and one or more other clients.

14. The system of claim 9, wherein generating the cell edge prediction is based at least in part on any one of: (i) historical roaming data, (ii) a Service Set Identifier of the client, (iii) a trajectory of the client, (iv) an estimation of whether the client can maintain its traffic, (v) a time of day, or (vi) any combination of (i)-(v).

15. The system of claim 9, wherein the cell edge prediction further comprises any one of: (i) probabilities of roaming to the one or more candidate APs, (ii) information associated with how the cell edge prediction is determined, or (iii) a combination of (i) and (ii).

16. A non-transitory computer-readable medium that stores a set of instructions which when executed perform a method executed by the set of instructions comprising:
predicting cell edges for a plurality of Access Points (APs) including a connected AP and one or more additional APs;
generating a cell edge prediction for a client connected to the connected AP, the cell edge prediction comprising:
an indication of one or more candidate APs for the client to roam to of the one or more additional APs, and
an estimated time the client will reach the cell edge of the connected AP; and
transmitting the cell edge prediction to the client.

17. The non-transitory computer-readable medium of claim 16, wherein the cell edges are any one of: (i) positions beyond which an ability of the client to exchange data with a network through the connected AP or additional AP associated with the cell edge becomes marginal or (ii) positions beyond which one or more of the connected AP and the one or more additional APs can provide a better connection for the client than the connected AP or additional AP associated with the cell edge.

18. The non-transitory computer-readable medium of claim 16, wherein predicting the cell edges comprises:
performing regression training based on one or more roaming training parameters.

19. The non-transitory computer-readable medium of claim 16, wherein generating the cell edge prediction is based at least in part on any one of: (i) historical roaming data, (ii) a Service Set Identifier of the client, (iii) a trajectory of the client, (iv) an estimation of whether the client can maintain its traffic, (v) a time of day, or (vi) any combination of (i)-(v).

20. The non-transitory computer-readable medium of claim 16, wherein the cell edge prediction further comprises any one of: (i) probabilities of roaming to the one or more candidate APs, (ii) information associated with how the cell edge prediction is determined, or (iii) a combination of (i) and (ii).
